(19) United States
(12) Patent Application Publication
(10) Pub. No.: US 2020/0283025 A1
(43) Pub. Date: Sep. 10, 2020

(54) VEHICLE CONTROL APPARATUS, VEHICLE, AND VEHICLE CONTROL METHOD

(71) Applicant: HONDA MOTOR CO., LTD., Tokyo (JP)

(72) Inventors: Shigehiro HONDA, Wako-shi (JP); Mahito SHIKAMA, Wako-shi (JP); Hironobu KIRYU, Wako-shi (JP); Yoshihiro ONIWA, Wako-shi (JP); Teppei KOMORI, Wako-shi (JP); Yoshihiro MORI, Wako-shi (JP); Tadahiko KANOH, Wako-shi (JP)

(21) Appl. No.: 16/883,566

(22) Filed: May 26, 2020

Related U.S. Application Data
(63) Continuation of application No. PCT/JP2017/043047, filed on Nov. 30, 2017.

(51) Int. Cl. B60W 60/00; B60W 30/14

(52) U.S. Cl. CPC B60W 60/0025; B60W 2554/80; B60W 60/0055; B60W 30/14

(57) ABSTRACT

A vehicle control apparatus that acquires information related to a peripheral state of a vehicle, and that can execute, based on the information, following vehicle control to cause the vehicle to perform automated driving by making the vehicle follow a preceding vehicle traveling in front of the vehicle is provided. The vehicle control apparatus performs detection or prediction, during the vehicle following control, of a movement of the preceding vehicle beyond a predetermined range in a lateral direction, and maintains, in response to the detection or the prediction of the movement of the preceding vehicle in the lateral direction, the vehicle following control in the lateral direction of the vehicle while decreasing an automated driving level of the vehicle and/or requesting a driver of the vehicle to perform a predetermined task.

### CROSS-REFERENCE TO RELATED APPLICATION(S)

This application is a continuation of International Patent Application No. PCT/JP2017/043047 filed on Nov. 30, 2017, the entire disclosures of which is incorporated herein by reference.

### BACKGROUND OF THE INVENTION

### Field of the Invention

The present invention relates to a vehicle control apparatus and method for controlling an automated driving vehicle, and more specifically to a preceding vehicle following control technique.

### Description of the Related Art

Automated driving of a vehicle is implemented by recognizing the peripheral environment of the vehicle, determining a track on which the vehicle is to travel based on the recognition result, and executing steering control to cause the vehicle to actually travel on the determined track. For example, the vehicle can be controlled such that the vehicle will follow the preceding vehicle and travel along the track on which the preceding vehicle is traveling.

In the case of preceding vehicle following control, if the preceding vehicle is to move in a lateral direction (in a lateral direction or a vehicle width direction intersecting a direction of travel of the vehicle), the following vehicle will move in the lateral direction in accordance with the movement of the preceding vehicle. That is, for example, if the preceding vehicle is to move to the side of an oncoming lane, the vehicle can move to the side of the oncoming lane in accordance with the preceding vehicle. In contrast, Japanese Patent Laid-Open No. 2016-162196 discloses a method in which the vehicle following control is ended when the preceding vehicle is to move beyond the lane boundary line.

A preceding vehicle can perform not only a lane change operation, but also, for example, an operation to avoid an obstacle. In the technique disclosed in Japanese Patent Laid-Open No. 2016-162196, vehicle following control will be ended even in such a case, and the vehicle following control may be started again in response to the preceding vehicle returning to its original lateral position. This can give a sense of incongruity to a user (occupant) of the vehicle.

### SUMMARY OF THE INVENTION

The present invention is provided to reduce the sense of incongruity given to the user in an automated driving vehicle that is performing a preceding vehicle following control operation.

According to the present invention, there is provided a vehicle control apparatus that performs automated-driving control of a vehicle, comprising: a sensor that acquires information related to a peripheral state of the vehicle; and a controller that can execute, based on the information, following vehicle control to cause the vehicle to perform automated driving by making the vehicle follow a preceding vehicle traveling in front of the vehicle, wherein the controller performs one of detection and prediction, during the execution of the vehicle following control, of a movement of the preceding vehicle beyond a predetermined range in a lateral direction, and maintains, in response to one of the detection and the prediction of the movement of the preceding vehicle in the lateral direction, the vehicle following control in the lateral direction of the vehicle while performing at least one of an operation to decrease an automated driving level of the vehicle and an operation to request a driver of the vehicle to perform a predetermined task.

According to another aspect of the present invention, there is provided a vehicle comprising a vehicle control apparatus that controls automated driving of a vehicle, wherein the vehicle control apparatus comprising: a sensor that acquires information related to a peripheral state of the vehicle; and a controller that can execute, based on the information, following vehicle control to cause the vehicle to perform automated driving by making the vehicle follow a preceding vehicle traveling in front of the vehicle, wherein the controller performs one of detection and prediction, during the execution of the vehicle following control, of a movement of the preceding vehicle beyond a predetermined range in a lateral direction, and maintains, in response to one of the detection and the prediction of the movement of the preceding vehicle in the lateral direction, the vehicle following control in the lateral direction of the vehicle while performing at least one of an operation to decrease an automated driving level of the vehicle and an operation to request a driver of the vehicle to perform a predetermined task.

Further features of the present invention will become apparent from the following description of exemplary embodiments (with reference to the attached drawings).

### BRIEF DESCRIPTION OF THE DRAWINGS

FIG. 1 is a block diagram of a vehicle control apparatus according to an embodiment;

FIG. 2A is a view showing an outline of following control according to the embodiment;

FIG. 2B is a view showing an outline of the following control according to the embodiment;

FIG. 2C is a view showing an outline of the following control according to the embodiment;

FIG. 2D is a view showing an outline of the following control according to the embodiment;

FIG. 3A is a view showing an outline of the following control according to the embodiment;

FIG. 3B is a view showing an outline of the following control according to the embodiment;

FIG. 4 is a flowchart showing an example of a procedure of processing executed by a vehicle control apparatus; and

FIG. 5 is a flowchart showing an example of a procedure of processing executed by the vehicle control apparatus.

### DESCRIPTION OF THE EMBODIMENTS

An embodiment according to the present invention will be described hereinafter with reference to the accompanying drawings.

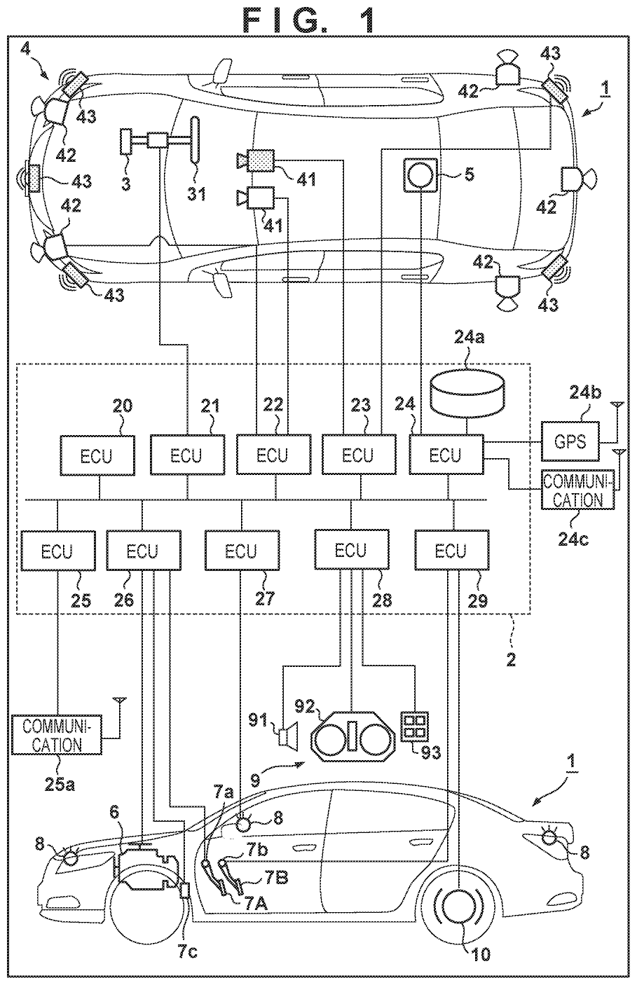

FIG. 1 shows a block diagram of a vehicle control apparatus for controlling a vehicle 1 according to an embodiment of the present invention. Note that although an explanation will be given assuming that the vehicle control apparatus is included in the vehicle 1, the vehicle control apparatus may be present outside the vehicle 1 and may control the vehicle 1 by communicating with the vehicle 1. In FIG. 1, the outline of the vehicle 1 is shown by a plan view and a side view. The vehicle 1 is, for example, a sedan-type four-wheeled vehicle. Note that the vehicle 1 may be a vehicle other than a four-wheeled vehicle such as a two-wheeled vehicle or the like.

The vehicle control apparatus shown in FIG. 1 includes a controller 2. The controller 2 includes a plurality of ECUs 20 to 29 communicably connected by an in-vehicle network. Each ECU (Electronic controller) includes a processor represented by a CPU (Central Processing Unit), a storage device such as a semiconductor memory, an interface with an external device, and the like. The storage device stores programs to be executed by the processor, data to be used by the processor for processing, and the like. Each ECU may include a plurality of processors, storage devices, and interfaces.

The functions and the like provided by the ECUs 20 to 29 will be described below. Note that the number of ECUs and the provided functions can be appropriately designed in the vehicle 1, and they can be subdivided or integrated as compared to this embodiment.

The ECU 20 executes control related to automated driving of the vehicle 1. In automated driving, at least one of steering and acceleration/deceleration of the vehicle 1 is automatically controlled.

The ECU 21 controls an electric power steering device 3. The electric power steering device 3 includes a mechanism that steers front wheels in accordance with a driving operation (steering operation) of a driver on a steering wheel 31. In addition, the electric power steering device 3 includes a motor that generates a driving force to assist the steering operation or automatically steer the front wheels, and a sensor that detects the steering angle. If the driving state of the vehicle 1 is automated driving, the ECU 21 automatically controls the electric power steering device 3 in correspondence with an instruction from the ECU 20 and controls the direction of travel of the vehicle 1.

The ECUs 22 and 23 perform control of detection units 41 to 43 that detect the peripheral state of the vehicle and information processing of detection results. Each detection unit 41 is a camera (to be sometimes referred to as the camera 41 hereinafter) that captures the front side of the vehicle 1. In this embodiment, two cameras are attached to the windshield inside the vehicle cabin at the front portion of the roof of the vehicle 1. When images captured by the cameras 41 are analyzed, the contour of a target or a division line (a white line or the like) of a lane on a road can be extracted.

The detection unit 42 is Light Detection and Ranging (LIDAR) (to be sometimes referred to as the LIDAR 42 hereinafter), and detects a target around the vehicle 1 or measures the distance to a target. In this embodiment, five LIDARs 42 are provided; one at each corner of the front portion of the vehicle 1, one at the center of the rear portion, and one on each side of the rear portion. The detection unit 43 is a millimeter wave radar (to be sometimes referred to as the radar 43 hereinafter), and detects a target around the vehicle 1 or measures the distance to a target. In this embodiment, five radars 43 are provided; one at the center of the front portion of the vehicle 1, one at each corner of the front portion, and one at each corner of the rear portion.

The ECU 22 performs control of one camera 41 and each LIDAR 42 and information processing of detection results. The ECU 23 performs control of the other camera 41 and each radar 43 and information processing of detection results. Since two sets of devices that detect the peripheral state of the vehicle are provided, the reliability of detection results can be improved. In addition, since detection units of different types such as cameras, LIDARs, and radars are provided, the peripheral environment of the vehicle can be analyzed multilaterally.

The ECU 24 performs control of a gyro sensor 5, a GPS sensor 24b, and a communication device 24c and information processing of detection results or communication results. The gyro sensor 5 detects a rotary motion of the vehicle 1. The course of the vehicle 1 can be determined based on the detection result of the gyro sensor 5, the wheel speed, or the like. The GPS sensor 24b detects the current position of the vehicle 1. The communication device 24c performs wireless communication with a server that provides map information and traffic information and acquires these pieces of information. The ECU 24 can access a map information database 24a formed in the storage device. The ECU 24 searches for a path from the current position to the destination.

The ECU 25 includes a communication device 25a for inter-vehicle communication. The communication device 25a performs wireless communication with another vehicle on the periphery and performs information exchange between the vehicles.

The ECU 26 controls a power plant 6. The power plant 6 is a mechanism that outputs a driving force to rotate the driving wheels of the vehicle 1 and includes, for example, an engine and a transmission. The ECU 26, for example, controls the output of the engine in correspondence with a driving operation (accelerator operation or acceleration operation) of the driver detected by an operation detection sensor 7a provided on an accelerator pedal 7A, or switches the gear ratio of the transmission based on information such as a vehicle speed detected by a vehicle speed sensor 7c. If the driving state of the vehicle 1 is automated driving, the ECU 26 automatically controls the power plant 6 in correspondence with an instruction from the ECU 20 and controls the acceleration/deceleration of the vehicle 1.

The ECU 27 controls lighting devices (headlights, taillights, and the like) including direction indicators 8. In the example shown in FIG. 1, the direction indicators 8 are provided in the front portion, door mirrors, and the rear portion of the vehicle 1.

The ECU 28 controls an input/output device 9. The input/output device 9 outputs information to the driver and accepts input of information from the driver. A voice output device 91 notifies the driver of the information by voice. A display device 92 notifies the driver of information by displaying an image. The display device 92 is arranged, for example, in the front surface of the driver's seat and constitutes an instrument panel or the like. Note that although a voice and display have been exemplified here, the driver may be notified of information using a vibration or light. Alternatively, the driver may be notified of information by a combination of some of the voice, display, vibration, and light. Furthermore, the combination or the notification form may be changed in accordance with the level (for example, the degree of urgency) of information of which the driver is to be notified.

An input device 93 is a switch group that is arranged at a position where the driver can perform an operation, is used to issue an instruction to the vehicle 1, and may also include a voice input device.

The ECU 29 controls a brake device 10 and a parking brake (not shown). The brake device 10 is, for example, a disc brake device which is provided for each wheel of the vehicle 1 and decelerates or stops the vehicle 1 by applying a resistance to the rotation of the wheel. The ECU 29, for example, controls the operation of the brake device 10 in correspondence with a driving operation (brake operation) of the driver detected by an operation detection sensor 7b provided on a brake pedal 7B. If the driving state of the vehicle 1 is automated driving, the ECU 29 automatically controls the brake device 10 in correspondence with an instruction from the ECU 20 and controls deceleration and stop of the vehicle 1. The brake device 10 or the parking brake can also be operated to maintain the stopped state of the vehicle 1. In addition, if the transmission of the power plant 6 includes a parking lock mechanism, it can be operated to maintain the stopped state of the vehicle 1.

(Processing Procedure)

In the vehicle control apparatus according to this embodiment, the ECU 20 executes control related to automated driving of the vehicle 1 based on the peripheral environment information acquired by at least one of the cameras 41, the LIDARs 42, and the radars 43. In this embodiment, the vehicle 1 travels by following a preceding vehicle traveling on the same lane. That is, the vehicle 1 executes acceleration/deceleration and steering control so as to travel along a track traveled by the preceding vehicle. In a case in which the preceding vehicle exceeds a predetermined range and moves in a lateral direction (the left-and-right direction or the vehicle width direction intersecting the direction of travel of the vehicle) or in a case in which such a movement is predicted while this vehicle following control is being performed, the vehicle 1 will request the driver to execute, for example, predetermined tasks such as periphery monitoring task, a steering wheel gripping task, and the like. Note that the vehicle 1 may reduce the automated driving level instead of requesting the execution of these kinds of predetermined tasks. However, in this case, at least the vehicle following control in the lateral direction will be continued until the end of the preceding vehicle following control is determined. Since it can be expected that the vehicle will shift to a state in which the vehicle following control will end when it is detected or predicted that the preceding vehicle will move in the lateral direction beyond the predetermined range, the above-described operation is performed to cause the driver to take a predetermined set of actions in advance. As a result, even if the preceding vehicle continues the lateral movement and makes a lane change or the like, the vehicle following control can be ended, and the control can be smoothly transferred to the driver because the driver will already be in a state in which he/she is executing the periphery monitoring task, the steering wheel gripping task, and the like. Also, on the other hand, it is possible to assume that the preceding vehicle will ultimately return to the current travel lane, for example, in a case in which the preceding vehicle has moved laterally to avoid an obstacle or the like. In this case, since the preceding vehicle following control will be continued, control to move the vehicle 1 in the lateral direction in accordance with the preceding vehicle will be executed. As a result, since the vehicle 1 will be driven automatically although the driver has executed the predetermined tasks or the automated driving level has been reduced, only a sufficiently small driving load is placed on the driver, and thus the overall driving load of the driver can be suppressed. In addition, for example, even in a case in which there is an obstacle that cannot be avoided by the vehicle following control, the driver can recognize and avoid the obstacle because the driver will be monitoring the periphery and gripping the steering wheel. Note that the predetermined range may be a lane region divided by lane boundary lines or a range which has a boundary which is apart from a lane boundary line by a predetermined distance such as 30 cm or the like. Also, in a road without vehicle lane markings, the predetermined range may be set as a range which is a predetermined distance from the center of the road or a range which is a predetermined distance from a track boundary (for example, the left end of a track). That is, the predetermined range can be set in accordance with the type of the road on which the vehicle 1 is traveling. Note that a track boundary in this case may be determined by roadside plantings, guardrails, and the like.

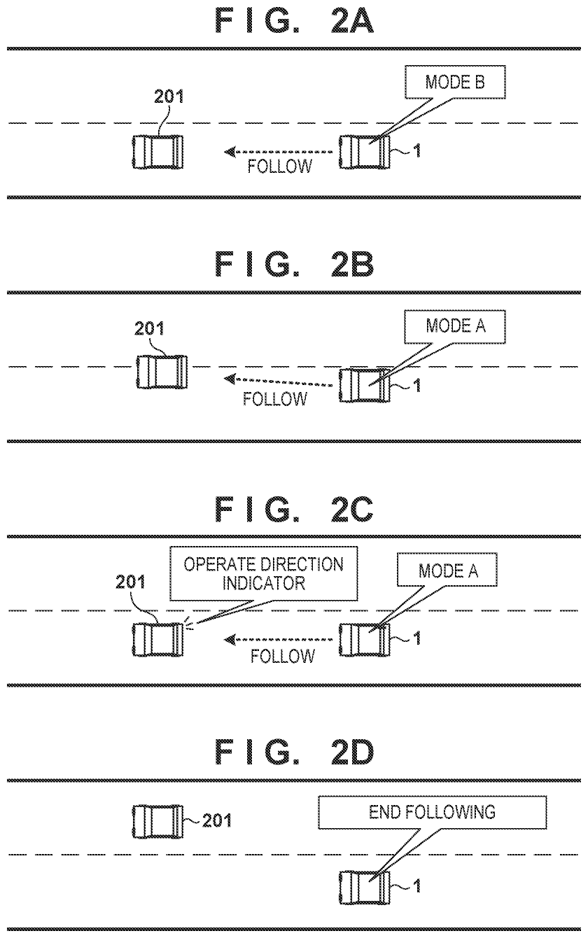

FIGS. 2A to 2D show an outline of the processing. In this processing, at least two vehicle following control modes are prepared, and the vehicle 1 will perform vehicle following driving, with respect to a preceding vehicle 201, by switching between these modes. However, these modes are merely an example, and neither a mode need be specified in advance nor control need be performed based on a plurality of modes. In this case, assume that the vehicle 1 will perform vehicle following driving in accordance with one of a first mode (a mode A) and a second mode (a mode B) in which at least one of a state with a higher automated driving level than the first mode and a state with fewer requested tasks to the driver than the first mode has been set. Note that the automated driving levels are automated driving levels defined by, for example, NHTSA (National Highway Traffic Safety Administration) of the United States. In this case, assume that the execution of predetermined tasks such as periphery monitoring task, a steering wheel gripping task, and the like is requested to the driver in mode A. On the other hand, assume that execution of such tasks is not requested in the mode B.

It may be set so that the vehicle 1 will execute the processing to be described below only when, for example, the self-vehicle is traveling under the mode B. That is, it may be set so that the vehicle 1 will be able to shift, depending on the state while continuing the automated driving operation, from only a state with a high automated driving level or a state with few tasks requested to the driver to a state with a relatively low automated driving level or a state with more tasks requested to the driver. As a result, it becomes possible to prevent frequent switching between automated driving and manual driving from occurring by, for example, executing this kind of processing in a state in a which the automated driving level is low originally.

FIG. 2A shows a state in which the vehicle 1 is performing automated driving by following the preceding vehicle 201. At this time, assume that the vehicle 1 is executing vehicle following control under the mode B described above. In a case in which it is detected that the preceding vehicle 201 has moved from this state to a position beyond a predetermined range defined by, for example, a lane boundary line as shown in FIG. 2B, the vehicle 1 will continue the vehicle following control by lowering the vehicle following control mode from the mode B to the mode A. Note that the vehicle 1 will execute vehicle following control within a predetermined range (for example, within the lane) in this case. At this time, for example, in a state in which the preceding vehicle 201 is being driven to straddle over a lane to avoid an obstacle, it can be assumed that the self-vehicle will not be able to avoid this object by performing vehicle following driving within the predetermined range. However, if the state shifts to the state shown in FIG. 2B, the driver can recognize such an object and execute an operation to avoid the object since the execution of predetermined tasks such as the periphery monitoring task, the steering wheel gripping task, and the like has already been requested to the driver. Also, since the vehicle following driving can be continued if the driver determines that the obstacle can be avoided by vehicle following driving, the driving load of the driver can be reduced.

Also, although FIG. 2B shows an example in which the vehicle 1 shifts the vehicle following driving mode from the mode B to the mode A in a case in which the self-vehicle has detected that the preceding vehicle 201 has moved beyond the predetermined range, the present invention is not limited to this. That is, in a case in which it can be predicted that the preceding vehicle 201 will move beyond the predetermined range, the vehicle following driving mode of the vehicle 1 can be shifted from the mode B to the mode A.

Prediction as to whether the preceding vehicle 201 will move beyond the predetermined range can be performed based on, for example, the amount of movement or the speed of movement of the preceding vehicle 201 in the lateral direction. In one example, in a case in which the preceding vehicle 201 has made a lateral movement of an amount exceeding a predetermined value and is, for example, traveling in an inclined manner in a direction nearing an adjacent lane, it can be assumed that the preceding vehicle 201 will move to this adjacent lane. Hence, in a case in which the amount of lateral movement (for example, from the center of the lane or a travel position of a predetermined time before) of the preceding vehicle 201 has exceeded a predetermined value, it can be predicted that the preceding vehicle 201 will move beyond the predetermined range. Also, in another example, in a case in which the preceding vehicle 201 has rapidly moved in the lateral direction in the direction of the adjacent lane, it can be assumed that the preceding vehicle 201 will move to this adjacent lane. Hence, in a case in which the speed of lateral movement of the preceding vehicle 201 exceeds a predetermined speed, it can be predicted that the preceding vehicle 201 will move beyond the predetermined range. Furthermore, prediction as to whether the preceding vehicle 201 will moved beyond the predetermined range can be made based on the distance from the position of the preceding vehicle 201 to a boundary (for example, the lane boundary line) of a predetermined region. That is, for example, in a case in which the preceding vehicle 201 is nearing the lane boundary line, it can be assumed that the preceding vehicle 201 will move beyond this lane boundary line. Hence, in a case in which the distance from the preceding vehicle 201 to the boundary of the predetermined range becomes a predetermined distance or less, it can be predicted that the preceding vehicle 201 will move beyond the predetermined range.

Note that thresholds to be used for prediction, such as the predetermined value, the predetermined speed, the predetermined distance, and the like described above, can be set in accordance with, for example, the position at which the preceding vehicle 201 was originally travelling, the vehicle width of the preceding vehicle 201, and the extent of a predetermined range (for example, the lane width). That is, the same predetermined values and the like need not be used for every road. For example, in a case in which the predetermined range can be set by lane boundary lines, a first predetermined value related to the amount of lateral movement when the lane width is wide can be a larger value than a second predetermined value related to the amount of lateral movement when the lane width is narrow. This is because it can be assumed that while the preceding vehicle can fall outside the predetermined range even if the amount of movement is small when the predetermined range is narrow, the preceding vehicle will not fall outside the predetermined range even if the amount of movement is the same when the predetermined range is wide. In a similar manner, a first predetermined speed of lateral movement when the predetermined range is wide may be set to be higher than a second predetermined speed of lateral movement when the predetermined range is narrow. In addition, a first predetermined distance from the preceding vehicle 201 to the boundary of the predetermined range when the predetermined range is wide can be set to be longer than a second predetermined distance to the boundary of the predetermined range when the predetermined range is narrow. That is, for example, if a long predetermined distance is set when the lane width is narrow, it will be determined that the preceding vehicle 201 is nearing the boundary of the predetermined range even when the preceding vehicle has made a slight lateral movement. Thus, it is preferable to set a short predetermined distance in some cases. On the other hand, for example, if a short predetermined distance is set when the lane width is wide, the self-vehicle will not predict that the preceding vehicle is going to move beyond the predetermined range unless the preceding vehicle 201 becomes extremely near the boundary of the predetermined range. Thus, a long predetermined distance can be set.

In addition, for example, a first predetermined value of the amount of lateral movement in a case in which the preceding vehicle 201 has moved from traveling on the left side of the lane to the right side of the lane can be set to be larger than a second predetermined value of the amount of lateral movement in a case in which the preceding vehicle 201 has moved from traveling near the center of the lane to the right side of the lane. This is effective for a case in which the amount of lateral movement of the preceding vehicle 201 is defined by using the travel position of a predetermined time before as a reference. That is, it can be considered that, compared to a case in which the preceding vehicle 201 moves from traveling near the center of the lane to the right side of the lane, a case in which the preceding vehicle moves from traveling on the left side of the lane to the right side of the lane has a low probability that the preceding vehicle will advance to an adjacent lane on the right side when the preceding vehicle moves laterally by about the same amount of movement. In a similar manner, a first predetermined speed of lateral movement in a case in which the preceding vehicle 201 has moved from traveling on the left side of the lane to the right side of the lane can be set to be higher than a second predetermined speed of lateral movement in a case in which the preceding vehicle 201 has moved from traveling near the center of the lane to the right side of the lane.

Note that, for example, a remaining distance from the preceding vehicle 201 to the boundary of the predetermined range can change between a case in which the preceding vehicle 201 has a wide vehicle width and a case in which the preceding vehicle has a narrow vehicle width. That is, the extent of the range in which the preceding vehicle 201 is able to move can change depending on the relationship between the vehicle width of the preceding vehicle 201 and the width of the predetermined region. In contrast, for example, if the predetermined value of the amount of lateral movement is set small when the remaining distance is long, the self-vehicle may predict that the preceding vehicle will move beyond the predetermined range even though the possibility that the preceding vehicle will make such movement is low. In addition, if the predetermined value of the amount of lateral movement is set large when the remaining distance is short, the self-vehicle may not predict that the preceding vehicle 201 will move beyond the predetermined range until the preceding vehicle is extremely near the boundary of the predetermined range or is beyond the predetermined range in some cases. Hence, it can be set so that the predetermined value of the amount of lateral movement will increase as the remaining distance increases in accordance with the vehicle width and the width of the predetermined range. In a similar manner, it may be set so that the predetermined speed of lateral movement will increase as the remaining distance increases and that the predetermined distance to the boundary of the predetermined range will increase as the remaining distance increases.

Note that, for example, the predetermined values, the predetermined speed, and the predetermined distance described above may be changed when the direction indicator (winker or blinker) of the preceding vehicle 201 is operating. When the direction indicator of the preceding vehicle 201 is in operating, it can be predicted that the probability that the preceding vehicle 201 will move in the direction indicated by the direction indicator is high. That is, when a direction indicator is operating, it can be predicted that a lateral movement of the preceding vehicle 201 in which the preceding vehicle moves beyond the predetermined range will occur even if the amount of lateral movement is small, the speed of lateral movement is low, or the distance to the boundary of the predetermined range is long. Hence, when the direction indicator is operating, at least one of a reduction of the predetermined value of the amount of lateral movement, a reduction of the speed of lateral movement, and an increase in the predetermined distance to the boundary of the predetermined range can be performed. As a result, when the direction indicator of the preceding vehicle is operating, the self-vehicle can quickly predict that the preceding vehicle will move greatly in the lateral direction and prompt the driver to execute the predetermined tasks in preparation for the upcoming departure of the preceding vehicle.

In addition, when the direction indicator of the preceding vehicle 201 is operating, the self-vehicle can perform at least one of an operation to request the driver to execute the predetermined tasks and an operation to reduce the automated driving level even before the movement of the preceding vehicle 201 is predicted based on the criteria described above. That is, the self-vehicle may determine, based on only the fact that the direction indicator of the preceding vehicle is operating, that the preceding vehicle 201 will move laterally beyond the predetermined range. Therefore, for example, the vehicle 1 can change the mode from the mode B to the mode A when the direction indicator of the preceding vehicle 201 has operated as shown in FIG. 2C while the self-vehicle is executing automated driving by vehicle following control in the state shown in FIG. 2A. As a result, since the self-vehicle can predict that the preceding vehicle will greatly move in the lateral direction when the direction indicator of the preceding vehicle is operating, the self-vehicle can prompt the driver to execute the predetermined tasks, at that point, in preparation for the upcoming departure of the preceding vehicle.

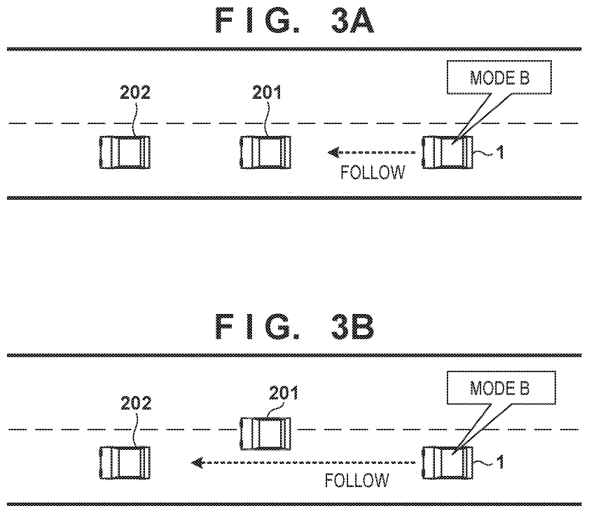

The vehicle 1 will end the vehicle following control when the preceding vehicle no longer satisfies the requirements to be a preceding vehicle such as a case in which the preceding vehicle 201 has entirely moved to an adjacent lane or the like as shown in, for example, FIG. 2D. However, for example, in a case in which a preceding vehicle (a second preceding vehicle 202) is present further ahead of the preceding vehicle 201 in the manner shown in FIG. 3A, the self-vehicle may follow this second preceding vehicle 202 traveling further ahead. Furthermore, even in a case in which the vehicle 1 has detected or predicted that the preceding vehicle 201 has moved beyond the predetermined range, the self-vehicle may follow the second preceding vehicle 202 without requesting the execution of the predetermined tasks or reducing the automated driving level when the second preceding vehicle 202 is present. That is, as shown in FIG. 3B, for example, when the preceding vehicle 201 has moved greatly, the vehicle 1 that has been following the preceding vehicle 201 under the mode B may switch the following target to the second preceding vehicle 202 while maintaining the operation under the mode B.

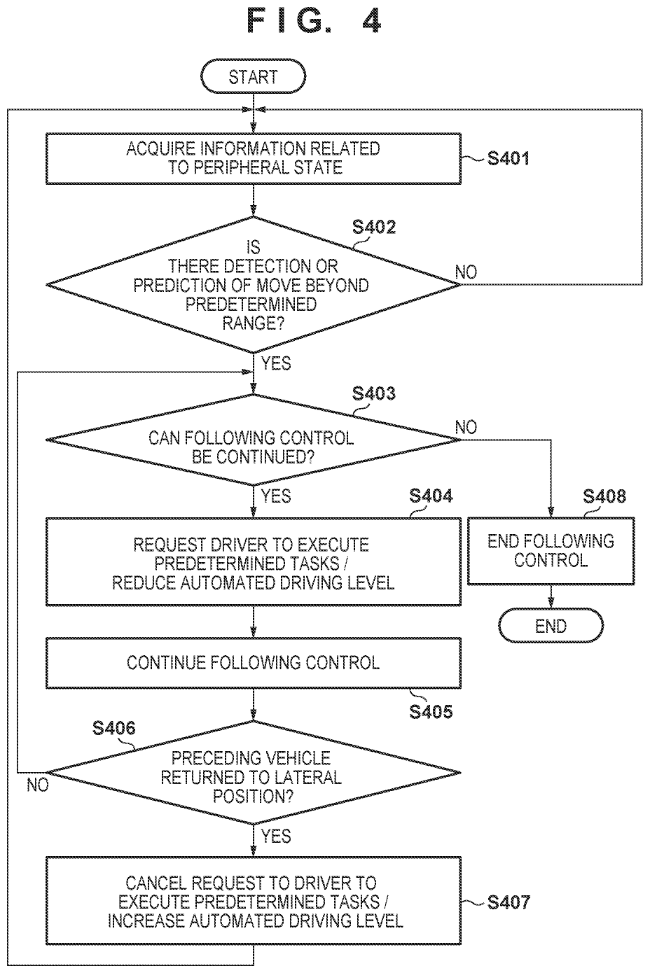

An example of the procedure of processing described above is illustrated in FIG. 4. For example, this processing can be executed by the vehicle control apparatus in response to the fact that the vehicle 1 has started vehicle following driving by the mode B described above. Note that this is merely an example, and the vehicle control apparatus may start this processing in response to the fact that the vehicle 1 has started vehicle following driving regardless of the mode of the vehicle 1.

In this processing, first, the vehicle control apparatus acquires information related to the peripheral state of the vehicle 1 (step S401). In this case, the vehicle control apparatus will particularly acquire the state information of a preceding vehicle that is traveling ahead and is the following target in the vehicle following control. The state information in this case can include, for example, the amount of lateral movement from the travel position at a predetermined time before or from the center of the lane, the speed of lateral movement, the vehicle width, and the presence/absence of the operation of a direction indicator of the preceding vehicle. Also, information related to the peripheral state can include, for example, the width of the lane, the information of each lane boundary line, and the like. Other pieces of information generally required for vehicle following driving will also be acquired.

Next, the vehicle control apparatus will determine, based on the acquired information, whether the fact that the preceding vehicle has moved beyond a predetermined range (for example, a range defined by the lane on which the self-vehicle is traveling) can be detected or whether such a movement can be predicted (step S402). For example, the vehicle control apparatus predicts whether the preceding vehicle will move beyond a boundary based on a determination as to whether the preceding vehicle is straddling the boundary of a predetermined region, such as a lane boundary line or the like, and on the relationship between the amount of lateral movement, the speed of lateral movement, or the distance from the preceding vehicle to the boundary of the predetermined region described above and a corresponding threshold. Subsequently, if the vehicle control apparatus neither detects nor predicts that the preceding vehicle has moved beyond the predetermined range (NO in step S402), the process returns to step S401, and the automated driving by vehicle following control is continued.

On the other hand, if the vehicle control apparatus detects or predicts that the preceding vehicle has moved beyond the predetermined range (YES in step S402), the vehicle control apparatus will determine whether vehicle following control can be continued (step S403). The vehicle control apparatus can determine that the vehicle following control cannot be continued in a case in which, for example, the preceding vehicle has entirely moved to an adjacent lane and does not satisfy the conditions to be the following target. If the vehicle following control cannot be continued (NO in step S403), the vehicle control apparatus will end the vehicle following control (step S408) and end the processing. Note that in a case in which the driver has started manual driving regardless of this processing, the vehicle control apparatus can end the vehicle following control and this processing. If the vehicle following control can be continued (YES in step S403), the vehicle control apparatus will continue the vehicle following control (step S405) while executing (step S404) at least one of an operation to request the driver to execute the predetermined tasks and an operation to reduce the automated driving level. Note that the request to the driver to execute the predetermined tasks can be performed by, for example, voice guidance by the voice output device 91, visual information display by the display device 92, and the like. Also, the predetermined tasks can include, for example, the periphery monitoring task and the steering wheel gripping task as described above. Note that the predetermined tasks are not limited to these, and for example, an arbitrary task that can facilitate the switching from automated driving to driving by the driver can be included in the predetermined tasks. In this manner, by requesting the driver to execute the predetermined tasks and decreasing the automated driving level, it is possible to continue vehicle following control in a state in which, for example, the driver is performing periphery monitoring.

Subsequently, the vehicle control apparatus determines whether the preceding vehicle has returned to the original lateral position (step S406). In this case, for example, whether the preceding vehicle that was straddling the predetermined range has entirely returned to traveling within the predetermined range will determined, or whether a state in which it cannot be predicted that the preceding vehicle will move beyond the predetermined range has been set will be determined based on the relationship between each above-described criterion and a corresponding threshold. If the vehicle control apparatus determines that the preceding vehicle has not returned to the original lateral position (NO in step S406), the process will return to step S403. On the other hand, If it is determined that the preceding vehicle has returned to the original lateral position (YES in step S406), the vehicle control apparatus will execute at least one of an operation to cancel the request to the driver to execute the predetermined tasks and an operation to return the decreased automated driving level to the original automated driving level (step S407). That is, at least one of an operation to cancel predetermined tasks of the execution request performed in step S404 and an operation to return the automated driving level to the original level will be performed. The process will return to step S401 after the process of step S407.

In this manner, in a case in which the preceding vehicle has temporarily moved in the lateral direction to, for example, avoid an obstacle or the like, the vehicle 1 can continue the vehicle following control while providing light tasks such as the periphery monitoring task and the like to the driver. As a result, in a case in which driving control is to be transferred to the driver while suppressing the load of the driver by continuing vehicle following control, it will be possible to smoothly perform such transfer of control.

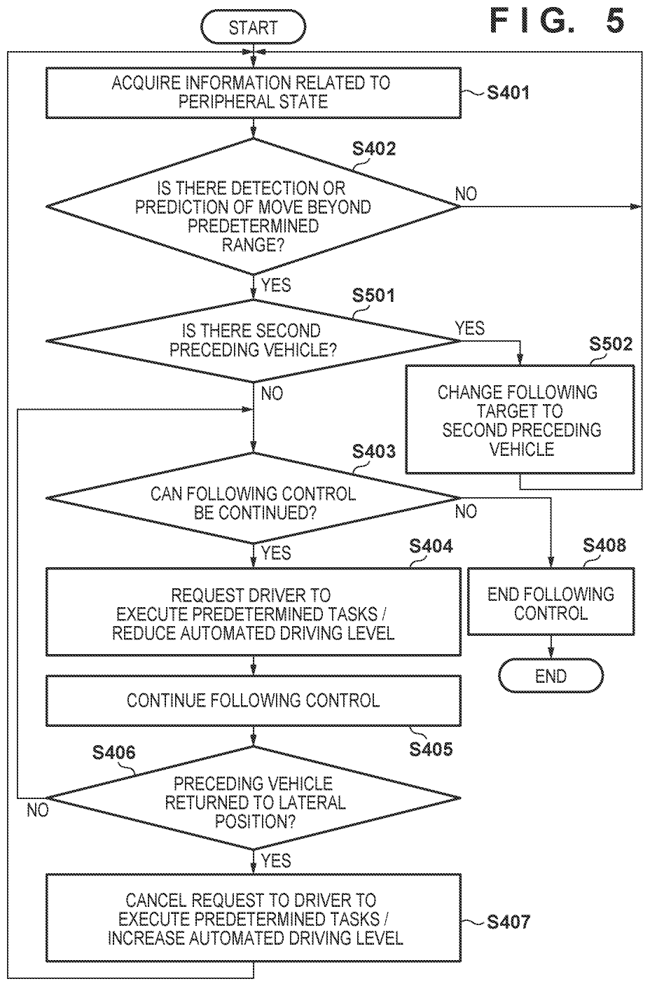

Note that as shown in FIG. 5, if the vehicle control apparatus has detected or predicted that the preceding vehicle has moved beyond the predetermined range (YES in step S402), the vehicle control apparatus can determine whether a second preceding vehicle is present (step S501). In this case, for example, if a second preceding vehicle is present (YES in step S501), the vehicle control apparatus will change the following target from the preceding vehicle to the second preceding vehicle (step S502), not request the driver to execute the predetermined tasks, and not change the automated driving level. On the other hand, if a second preceding vehicle is not present (NO in step S501), the vehicle control apparatus can shift the process to step S403. As a result, even in a case in which the preceding vehicle has departed from the predetermined range and has laterally moved or in a case in which such a movement has been predicted, it becomes possible to make, in accordance with the detection of a second preceding vehicle, the vehicle 1 follow the second preceding vehicle that can be followed. In addition, by not performing an operation to request the driver to execute the predetermined tasks and not changing the automated driving level, it becomes possible sufficiently suppress the driving load of the driver to a low load.

### Summary of Embodiment

1. A vehicle control apparatus according to the above-described embodiment is a vehicle control apparatus that controls automated driving of a vehicle, characterized by comprising:

acquisition means (for example, 41, 42, 43) for acquiring information related to a peripheral state of the vehicle; and

control means (for example, 2) that can execute, based on the information, following vehicle control to cause the vehicle to perform automated driving by making the vehicle follow a preceding vehicle traveling in front of the vehicle,

wherein the control means

performs one of detection and prediction, during the execution of the vehicle following control, of a movement of the preceding vehicle beyond a predetermined range in a lateral direction, and

maintains, in response to one of the detection and the prediction of the movement of the preceding vehicle in the lateral direction, the vehicle following control in the lateral direction of the vehicle while performing at least one of an operation to decrease an automated driving level of the vehicle and an operation to request a driver of the vehicle to perform a predetermined task.

According to this embodiment, in a case in which a preceding vehicle has greatly moved in the lateral direction, it is possible to create a state in which the driver can immediately execute control when the control needs to be returned to the driver by continuing vehicle following control by issuing a predetermined task request to the driver and by reducing the automated driving level. Also, at this time, the vehicle can be made to travel in accordance with the vehicle following control as long as possible, and the load of the driver can be reduced. Furthermore, it is possible to smoothly and quickly return the control to the driver in response to a state in which the preceding vehicle has further greatly moved and cannot be set as the preceding vehicle in the vehicle following control.

2. The vehicle control apparatus according to the above-described embodiment is characterized in that the control means can execute the vehicle following control by switching between a first mode and a second mode which is set with at least one of a state in which the automated driving level is higher than the automated driving level of the first mode and a state there are few tasks requested to the driver of the vehicle, and

the control means switches, while the vehicle following control is executed under the second mode, the vehicle following control from the second mode to the first mode in response to one of the detection and the prediction of the movement of the preceding vehicle in the lateral direction.

According to this embodiment, since the above-described control is executed when the self-vehicle is operating in an operation mode with a high automated driving level or an operation mode with few tasks requested to the driver, it is possible to prevent a state in which a control operation for returning the control to the driver by such control operations will be performed excessively.

3. The vehicle control apparatus according to the above-described embodiment is characterized in that in a case in which one of the detection and the prediction of the movement of the preceding vehicle in the lateral direction during the execution of the vehicle following control has been made, the control means causes the vehicle to follow the movement of the preceding vehicle in the lateral direction within the predetermined range.

According to this embodiment, by restricting a region in which the self-vehicle can move to be within a predetermined range even while the self-vehicle is following the preceding vehicle, it is possible to prevent the occurrence of a phenomenon in which the self-vehicle will depart from the lane due to the following operation or the like. In addition, in a case in which the preceding vehicle has moved in the lateral direction to avoid, for example, an obstacle, the self-vehicle can avoid the obstacle by following the preceding vehicle by causing the self-vehicle to travel in accordance with the vehicle following control.

4. The vehicle control apparatus according to the above-described embodiment is characterized in that the control means predicts the movement of the preceding vehicle in the lateral direction based on at least one of an amount of lateral movement of the preceding vehicle, a speed of lateral movement of the preceding vehicle, a distance from the preceding vehicle to a boundary of the predetermined range.

According to this embodiment, the self-vehicle can determine, based on the movement of the preceding vehicle, that the preceding vehicle will move greatly in the lateral direction as the preceding vehicle increasingly falls outside from the predetermined range. In addition, for example, even if the amount of movement is small, it is possible to estimate that the preceding vehicle will fall outside of the predetermined range when the preceding vehicle is moving rapidly in the lateral direction or the like. Furthermore, for example, since a preceding vehicle whose distance to the boundary of the predetermined range can fall outside the predetermined range by just a small amount of movement, it is possible to predict that the preceding vehicle traveling at such a position is a vehicle that will move beyond the predetermined range in the lateral direction. Therefore, in a case in which the preceding vehicle is a vehicle traveling near the boundary of the predetermined range, the automated driving of the self-vehicle can be continued by prompting the driver to pay attention to the movement of the preceding vehicle. Note that whether the preceding vehicle will move beyond the predetermined range in the lateral direction can be predicted with high accuracy by integrally using the amount of lateral movement of the preceding vehicle, the speed of lateral movement of the preceding vehicle, and the distance from the preceding vehicle to the boundary of the predetermined range.

5. The vehicle control apparatus according to the above-described embodiment is characterized in that in a case in which an operation of a direction indicator of the preceding vehicle has been detected, the control means will perform at least one of an operation to reduce a threshold of the amount of lateral movement, an operation to reduce a threshold of the speed of lateral movement, and an operation to increase a threshold of the distance to be used for predicting when the movement of the preceding vehicle in the lateral direction is predicted.

According to this embodiment, in a case in which a predetermined movement is detected while the preceding vehicle is operating a direction indicator, the self-vehicle can quickly predict that the preceding vehicle will greatly move in the lateral direction and prompt the driver to execute the predetermined task in preparation for the upcoming departure of the preceding vehicle.

6. The vehicle control apparatus according to the above-described embodiment is characterized in that in a case in which an operation of a direction indicator of the preceding vehicle is detected, the control means will perform at least one of an operation to reduce the automated driving level and an operation to request the driver of the vehicle to execute a predetermined task even before one of the detection and the prediction of the movement of the preceding vehicle in the lateral direction.

According to this embodiment, since it can be predicted that the preceding vehicle will greatly move in the lateral direction in a case in which the direction indicator of the preceding vehicle is operating, the self-vehicle can prompt the driver to execute the predetermined tasks, at that point, in preparation for the upcoming departure of the preceding vehicle.

7. The vehicle control apparatus according to the above-described embodiment is characterized in that the predetermined task includes at least one of a periphery monitoring task and a steering wheel gripping task to be performed by the driver.

According to this embodiment, control can be returned to the driver as needed while the automated driving is continued by making the driver perform periphery monitoring. In addition, steering control can be transferred to the driver as needed while the automated driving is continued by making the driver grip the steering wheel. Furthermore, automated driving (vehicle following control) can be continued even while imposing the driver with such low load tasks.

8. The vehicle control apparatus according to the above-described embodiment is characterized in that if a second preceding vehicle traveling in front of the preceding vehicle is detected in one of a case in which the movement of the preceding vehicle in the lateral direction has occurred and in a case in which the lateral movement of the preceding vehicle in the lateral direction has been predicted, the control means will execute the vehicle following control with respect to the second preceding vehicle without decreasing the automated driving level and without requesting the driver of the vehicle to execute the predetermined task.

According to this embodiment, in a case in which a second preceding vehicle is present and the self-vehicle can follow the second preceding vehicle, the vehicle following control can be continued by setting the second preceding vehicle as the following target. As a result, the load of the driver can be reduced.

9. The vehicle control apparatus according to the above-described embodiment is characterized in that the predetermined range is set based on a lane boundary line.

According to this embodiment, in a case in which the preceding vehicle is to move in the direction of another lane, transfer of vehicle control to the driver can be performed smoothly by providing the driver of the vehicle with predetermined tasks or by decreasing the automated driving level when the vehicle following control is to end after the preceding vehicle has made a lane change or the like.

10. A vehicle according to the above-described embodiment is characterized by comprising a vehicle control apparatus described above.

According to this embodiment, appropriate control can be executed in real time by quickly executing the above-described processing in the vehicle.

11. A method according to the above-described embodiment is a vehicle control method executed by a vehicle control apparatus that controls automated driving of a vehicle, the method characterized in that

the vehicle control apparatus comprises acquisition means (for example, 41, 42, 43) for acquiring information related to a peripheral state of the vehicle, and control means (for example, 2) that can execute, based on the information, following vehicle control to cause the vehicle to perform automated driving by making the vehicle follow a preceding vehicle traveling in front of the vehicle,

wherein the vehicle control method comprises

performing one of detecting and predicting (for example, S402), during the execution of the vehicle following control, a movement of the preceding vehicle beyond a predetermined range in a lateral direction, and

maintaining (for example, S404, S406), in response to one of the detecting and the predicting of the movement of the preceding vehicle in the lateral direction, the vehicle following control in the lateral direction of the vehicle while performing at least one of an operation to decrease an automated driving level of the vehicle and an operation to request a driver of the vehicle to perform a predetermined task.

According to this embodiment, in a case in which a preceding vehicle has greatly moved in the lateral direction, it is possible to create a state in which the driver can immediately execute control when the control needs to be returned to the driver by continuing vehicle following control by issuing a predetermined task request to the driver and by reducing the automated driving level. Also, at this time, the vehicle can be made to travel in accordance with the vehicle following control as long as possible, and the load of the driver can be reduced. Furthermore, it is possible to smoothly and quickly return the control to the driver in response to a state in which the preceding vehicle has further greatly moved and cannot be set as the preceding vehicle in the vehicle following control.

The present invention is not limited to the above-described embodiments, and various changes and modifications can be made within the spirit and scope of the present invention. Therefore, to apprise the public of the scope of the present invention, the following claims are made.

According to the present invention, it is possible to reduce, in an automated driving vehicle that performs preceding vehicle following control, the sense of incongruity given to a user of the vehicle.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A vehicle control apparatus that controls automated driving of a vehicle, comprising:
a sensor that acquires information related to a peripheral state of the vehicle; and
a controller that can execute, based on the information, following vehicle control to cause the vehicle to perform automated driving by making the vehicle follow a preceding vehicle traveling in front of the vehicle,
wherein the controller
performs one of detection and prediction, during the execution of the vehicle following control, of a movement of the preceding vehicle beyond a predetermined range in a lateral direction, and
maintains, in response to one of the detection and the prediction of the movement of the preceding vehicle in the lateral direction, the vehicle following control in the lateral direction of the vehicle while performing at least one of an operation to decrease an automated driving level of the vehicle and an operation to request a driver of the vehicle to perform a predetermined task.

2. The vehicle control apparatus according to claim 1, wherein the controller can execute the vehicle following control by switching between a first mode and a second mode which is set with at least one of a state in which the automated driving level is higher than the automated driving level of the first mode and a state there are few tasks requested to the driver of the vehicle, and
the controller switches, while the vehicle following control is executed under the second mode, the vehicle following control from the second mode to the first mode in response to one of the detection and the prediction of the movement of the preceding vehicle in the lateral direction.

3. The vehicle control apparatus according to claim 1, wherein in a case in which one of the detection and the prediction of the movement of the preceding vehicle in the lateral direction during the execution of the vehicle following control has been made, the controller causes the vehicle to follow the movement of the preceding vehicle in the lateral direction within the predetermined range.

4. The vehicle control apparatus according to claim 1, wherein the controller predicts the movement of the preceding vehicle in the lateral direction based on at least one of an amount of lateral movement of the preceding vehicle, a speed of lateral movement of the preceding vehicle, a distance from the preceding vehicle to a boundary of the predetermined range.

5. The vehicle control apparatus according to claim 4, wherein in a case in which an operation of a direction indicator of the preceding vehicle has been detected, the controller will perform at least one of an operation to reduce a threshold of the amount of lateral movement, an operation to reduce a threshold of the speed of lateral movement, and an operation to increase a threshold of the distance to be used for predicting when the movement of the preceding vehicle in the lateral direction is predicted.

6. The vehicle control apparatus according to claim 1, wherein in a case in which an operation of a direction indicator of the preceding vehicle is detected, the controller will perform at least one of an operation to reduce the automated driving level and an operation to request the driver of the vehicle to execute a predetermined task even before one of the detection and the prediction of the movement of the preceding vehicle in the lateral direction.

7. The vehicle control apparatus according to claim 1, wherein the predetermined task includes at least one of a periphery monitoring task and a steering wheel gripping task to be performed by the driver.

8. The vehicle control apparatus according to claim 1, wherein if a second preceding vehicle traveling in front of the preceding vehicle is detected in one of a case in which the movement of the preceding vehicle in the lateral direction has occurred and in a case in which the lateral movement of the preceding vehicle in the lateral direction has been predicted, the controller will execute the vehicle following control with respect to the second preceding vehicle without decreasing the automated driving level and without requesting the driver of the vehicle to execute the predetermined task.

9. The vehicle control apparatus according to claim 1, wherein the predetermined range is set based on a lane boundary line.

10. A vehicle comprising a vehicle control apparatus that controls automated driving of a vehicle,
wherein the vehicle control apparatus comprising:
a sensor that acquires information related to a peripheral state of the vehicle; and
a controller that can execute, based on the information, following vehicle control to cause the vehicle to perform automated driving by making the vehicle follow a preceding vehicle traveling in front of the vehicle,
wherein the controller
performs one of detection and prediction, during the execution of the vehicle following control, of a movement of the preceding vehicle beyond a predetermined range in a lateral direction, and
maintains, in response to one of the detection and the prediction of the movement of the preceding vehicle in the lateral direction, the vehicle following control in the lateral direction of the vehicle while performing at least one of an operation to decrease an automated driving level of the vehicle and an operation to request a driver of the vehicle to perform a predetermined task.

11. A vehicle control method executed by a vehicle control apparatus that controls automated driving of a vehicle, wherein the vehicle control apparatus is configured to acquire information related to a peripheral state of the vehicle, and to be able to execute, based on the information, following vehicle control to cause the vehicle to perform automated driving by making the vehicle follow a preceding vehicle traveling in front of the vehicle, the vehicle control method comprises:
performing one of detecting and predicting, during the execution of the vehicle following control, a movement of the preceding vehicle beyond a predetermined range in a lateral direction, and
maintaining, in response to one of the detecting and the predicting of the movement of the preceding vehicle in the lateral direction, the vehicle following control in the lateral direction of the vehicle while performing at least one of an operation to decrease an automated driving level of the vehicle and an operation to request a driver of the vehicle to perform a predetermined task.
